(19) United States
(12) Patent Application Publication
(10) Pub. No.: US 2002/0118116 A1
(43) Pub. Date: Aug. 29, 2002

(54) Multi-sensor detector with adjustable sensor sampling parameters

(76) Inventors: Lee D. Tice, Bartlett, IL (US); Vincent Y. Chow, Hanover Park, IL (US)

Correspondence Address: WELSH & KATZ, LTD, 120 SOUTH RIVERSIDE PLAZA, 22st FLOOR, Chicago, IL, 60606, US

(21) Appl. No.: 09/795,981

(22) Filed: Feb. 28, 2001

(51) Int. Cl. G08B 17/10

(52) U.S. Cl. 340/632; 340/628

(57) ABSTRACT

A dual sensor detector incorporates a fire sensor, such as a smoke or heat sensor, and a gas sensor. Control circuitry is coupled to the sensors. In response to a sensed fire condition, such as due to heat or smoke, a constant sample rate sampling parameter, such as a sample time interval or a drive amplitude, is increased for the second sensor so as to increase its signal-to-noise ratio and resolution. The second sensor will be operated with the increased sample interval or drive amplitude so long as the first sensor continues to exhibit the detection of a condition. When the first sensor drops outs of the detection of a condition, the alterable parameter of the second sensor is reset to its quiescent state which draws a lower current value.

### FIELD OF THE INVENTION

The invention pertains to ambient condition detectors. More particularly, the invention pertains to such detectors which incorporate multiple sensors wherein an output signal from one of the sensors is used to alter a performance characteristic of a second sensor.

### BACKGROUND OF THE INVENTION

It is known to incorporate more than one sensor into an ambient condition detector. Tice U.S. Pat. No. 5,831,524, entitled System and Method for Dynamic Adjustment of Filtering in an Alarm System assigned to the assignee hereof discloses such a system. The noted Tice et al patent addressed apparatus and methods for altering a form of processing of an output from a sensor.

Another known multiple sensor detector incorporates a smoke sensor which is used to alter a sample rate of a gas sensor. In the absence of a signal from the smoke sensor, the gas sensor samples at a first relatively low rate. In the presence of an alarm indicating signal from the smoke sensor, the sampling rate of the gas sensor is substantially increased to thereby shorten its response time to emitting an alarm indicating signal.

There continues to be a need for devices and methods of operating multiple sensor detectors so as to further enhance signal to noise ratio, and shorten response time while at the same time reducing average current.

### SUMMARY OF THE INVENTION

A variable parameter detector which incorporates at least two sensors can be switched between first and second modes of operation depending on an output signal from one of the sensors. In the absence of an alarm indicating signal from the first sensor, an output signal from the second sensor, which is sampled at a constant rate, is processed with one of its alterable parameters having a first value. In response to the first sensor changing state and emitting a detected condition indicating signal, the alterable parameter of the output signal of the second sensor is driven from a first value to a second value during the period of time where the first sensor is exhibiting the detected condition. When the second sensor has a parameter which is exhibiting the second value, its performance, using a selected indicium, is altered so as to improve over-all detector response.

The alterable sensor parameters can be selected from a group which includes an alterable sample interval, an alterable sample drive amplitude, an alterable sample drive time parameter, an alterable sample drive frequency parameter, and an alterable sample drive modulation parameter. In one embodiment, a sample interval of the second detector can be switched from a relatively short interval, used in the absence of an alarm indicating signal from the first sensor, to a longer sample interval used in the presence of an alarm indicating signal from the first sensor.

So long as the second sensor is being operated with a relatively short sample interval, as an exemplary alterable parameter, it will draw a relatively low average current. In this operational mode, the second sensor may well have a lower-than-desired signal-to-noise ratio given a relatively short sample interval. However, it will exhibit a relatively low average current draw. Further, in the presence of large concentrations of the sensed condition, it will produce an output indicative of an alarm condition. For example, in the presence of a fast flaming fire, when the second sensor is a gas sensor, it can be expected to have a gross gas response, in the absence of an alarm indicating signal from a first sensor implemented as a fire sensor, that can be detected even with a short sample interval.

Where the first sensor starts to exhibit an alarm condition, based on its sensing technology, and causes the second sensor to enter an altered parameter state, for example by increasing the sample interval or drive amplitude of the second sensor, the signal-to-noise ratio will increase, and the resolution increases. The average current increases during the time of the longer sample interval or increased drive amplitude. However, this increased current is only exhibited in the presence of an alarm indicating output from the first sensor. Hence, over a long interval of time the average current will continue to be relatively low. In yet another aspect, if the first sensor should in some way fail, the second sensor more likely than not will continue to function at the lower resolution, lower current mode and will still respond to relatively large increases in spaced sensed ambient condition.

In yet another aspect, the average current can be reduced by pulsing one of an emitting element and a sensing element in a gas sensor with a pulse width less than the response time of the respective element. By selecting a pulse width that is less than the respective response time, coupled with a relatively long sample period, a further reduction in average current can be achieved. Additionally, the short activating pulse widths can be supplied at increased amplitudes to increase power. This in turn compensates for shorter pulse widths and keeps applied energy at acceptable levels.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is block diagram of the system in accordance with the present invention, and

FIGS. 2A-2C are timing diagrams illustrating aspects of operation of the system of FIG. 1.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

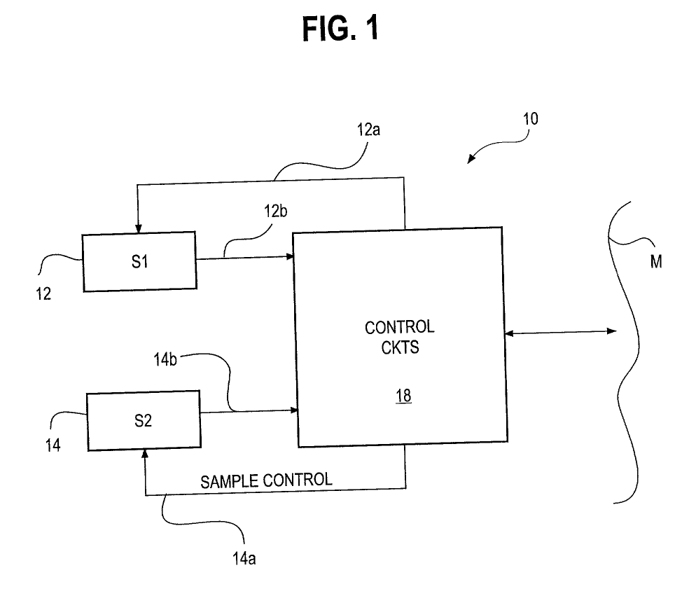

FIG. 1 is a block diagram of a system 10 which incorporates two ambient condition sensors 12, 14. The sensors 12, 14 have outputs which are coupled to a control element 18. The control element 18, as those of skill in the art will understand, could be implemented as hardwired logic or could incorporate a processor programmed with pre-stored instructions all without departing from the spirit and scope of the present invention.

The sensors 12, 14 respond to different types of ambient conditions. For example, the sensor 12 could be implemented as a smoke sensor or a heat sensor using any one of a variety of available technologies. In one implementation, a photo-electric smoke sensor could be used.

The sensor 14 could be implemented as, for example, a gas sensor. A typical example includes carbon dioxide sensors. It is known that carbon dioxide can be sensed using a variety of technologies including non-dispersive infrared technologies such as photo-acoustic as well as various types of thermal pile technologies. The exact nature and characteristics of the gas sensor are not a limitation of the present invention.

As illustrated in FIG. 1, in the system 10 the control element 18 is coupled to a sensor 12 via a control 12a and receives signals from the sensor 12 via an output line 12b. Similarly, the control element 18 is coupled to sensor 14 by a control 14a and receives output signals on a line 14b.

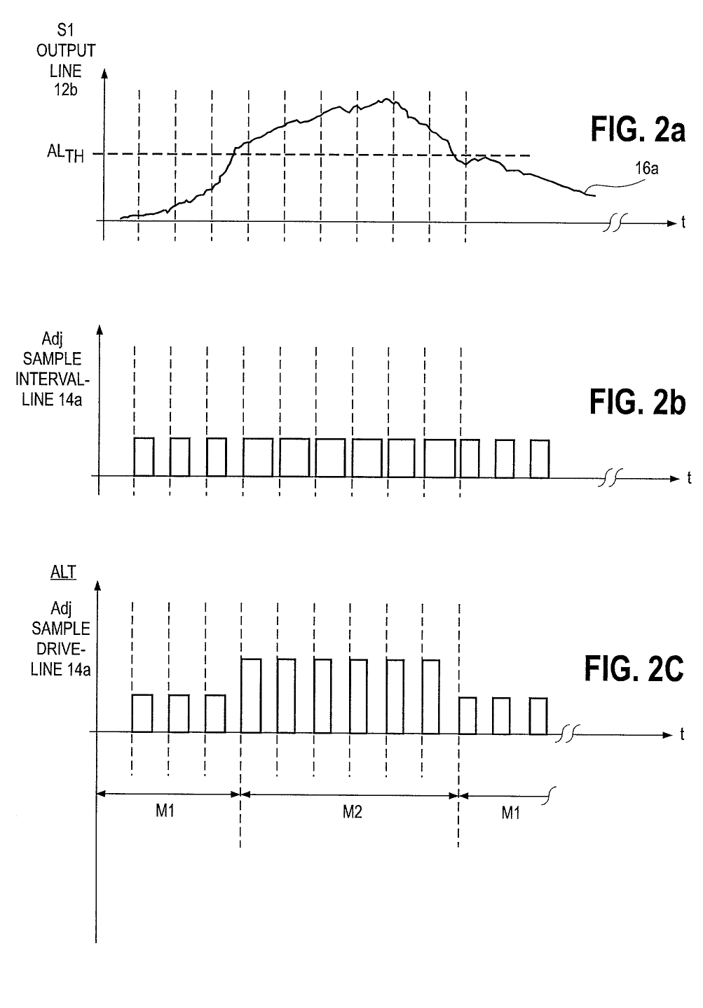

In accordance with the present invention, the sensor 12 produces outputs indicative of smoke or heat in accordance with the respective technology as illustrated by graph 16a of FIG. 2A. As illustrated in FIG. 2A as smoke or heat increases over a period of time, an output from sensor S1, via line 12b, is received by control element 18 and processed. It will also be understood that some portion of the processing could be conducted by sensor 12 without departing from the spirit and scope of the present invention. In one aspect, the system 10 can establish that the sensed ambient condition, such as smoke or heat, has crossed a pre-established threshold, AL_{TH}, which is regarded as being indicative of the presence of a sufficient level of the respective ambient condition as to represent a detected condition state.

Simultaneously with receiving an output from sensor 12, the control element 18 has been receiving sampled outputs from sensor 14. As illustrated in FIG. 2B, control element 18 via line 14a transmits variable width, constant period sample control signals to sensor 14. The sensor 14 is thus operated in two different modes.

In mode M1, the sensor 14 is sampled with a sample time on the order of 5 milliseconds. This results in a relatively low resolution, gross gas measurement with a relatively low signal-to-noise ratio. Representative sample periods could be, for example, in a range of 3 to 8 seconds.

In mode M1, sensor 14 is functioning at a very low average current level. In this mode, the sensor 14 is functional to detect the level of carbon dioxide in the ambient atmosphere and is usable for detecting large fires or large changes in carbon dioxide concentration. While the signal-to-noise ratio is relatively low in this mode, sensor 14 can be expected to appropriately respond to carbon dioxide levels in the ranges of 1000 parts per million or larger. Thus, large quantities of carbon dioxide are detectable. Such quantities can be present either alone or as a by-product of a large fire even in the presence of noise on the order of 300 parts per million.

Control element 14 can maintain a running average of sample values from detector 14 while in mode M1 which can be used to suppress some of the noise. Changes in carbon dioxide on the order of 600 to 1000 parts per million can be quickly detected despite the fact that the smoke or thermal sensor 12 may not as yet have generated a sufficient signal for the control element 18 to have detected the presence of an alarm condition.

Where the output from sensor 12 has in fact crossed an alarm threshold, as illustrated in FIG. 2A, the sensor 14 is switched via control element 18 to a second mode, M2. In mode M2, sensor 14 is sampled at the same rate but with a substantially longer sample interval. For example, instead of a 5 millisecond sample interval, the sensor 14 can be sampled for 20 milliseconds. This in turn substantially improves the signal to noise ratio making it possible to detect changes in carbon dioxide which exceed 200 parts per million.

In mode M2, noise is reduced to on the order of 50 parts per million as a result of a substantially longer sample interval. Thus, a higher resolution lower noise signal is present in mode M2. In contradistinction to the mode M1, in mode M2, sensor 14 when active, draws a substantially higher current perhaps 600 microamps versus 200-250 microamps as in mode M1 operation.

Signals from sensor 14 can be processed with a different running average when in mode M2. For example, this average can be implemented by operating in mode M1 for nine samples and then switching to mode M2 for one sample. With an exemplary sampling period of 5 seconds, the mode M1 average will be updated every five seconds for nine samples. The mode M2 signal will be updated every tenth sample, every 50 seconds. Average current flow required for sensor 14 with this type of averaging is the average of the current required for the updates, namely:

[9*250+1*600]÷10=285 microamps.

The above described averaging process takes advantage of improved resolution and improved signal to noise ratio in the M2 mode of operation and requires 285 microamps of current as opposed to the 250 microamps of current in the M1 mode of operation. This is still significantly less than operating the sensor 14 in the M2 mode of operation continuously which produces an average current on the order of 600 microamps.

Those of skill in the art will understand that the number of samples in the running averages can be changed as the function of how often the average is updated. For example, in mode M1, a running average with a time constant on the order of 128 samples can be implemented. In mode M2, a time constant of 16 samples can be used to achieve a similar time reference for measuring the change in carbon dioxide concentration. Other averages or filtering processes can be used without departing from the spirit and scope of the present invention.

Further with respect to FIG. 2, when the signal 16a from the sensor 12 drops below the pre-alarm or alarm indicating threshold, the control element 18 reverts to the M1 mode of operation of sensor 14.

It will be understood that a variety of processing criteria could be used with the output of sensor 12 to switch modes of operation of sensor 14. These all come within the spirit and scope of the present invention. Alternate criteria include rates of increase of the signals on line 12b or various types of patterns indicative of fire.

Other drive characteristics of sensor 14 can be altered provided the sampling period is maintained at a constant value, such as 5 seconds, 10 seconds or the like. Alternates include changing the amplitude of the sample drive signal, changing a frequency parameter within the sample drive signal, or, altering a modulation parameter of the sample drive signal. FIG. 2C illustrates the process described above, FIG. 2B, where the drive amplitude to the sensor 14 is modulated.

In yet another aspect of the invention where sensor 14 includes a source of radiant energy, such as is the case with a photo-acoustic carbon monoxide sensor, either the source of radiant energy or the sensor, a microphone, can be activated, pulsed or sampled, for duration that is shorter than the response time of one of the transmitter or the receiver. This produces a very short pulse and results in a very low average current. For example, where a receiver has a response time, defined to be the time interval between 10 percent to 90 percent of full output signal to a designated input which could be on the order of 100 milliseconds, the respective transmitter could be pulsed for less than 100 milliseconds. Where the transmitter is pulsed at a fixed rate, illustrated in FIG. 2, for example with a period of three to eight seconds, the average current will be reduced.

Where the system 10 is to be coupled to a medium M, such as a wired medium which is part of an alarm system, devices, such as system 10, can be powered off of electrical energy received from the medium M. In such environments, it is desirable to be able to reduce the current per unit since numerous detectors, such as the system 10, might be coupled to the medium M. By reducing the average current as described above, additional detectors, such as the system 10, can be coupled to the same wired medium M than is the case for higher average current detectors.

In another alternate, the electrical energy received from the medium M by the system 10 can be increased where the control element 18 energizes or pulses the sensor 14 with an increased voltage. Pulsing the transmitter or source in sensor 14 for a time interval less than its response time, but with a higher voltage, makes it possible to increase the energy delivered to the source or transmitter. Thus, where the sensor 14 is a photo-acoustic carbon monoxide detector, for example, the source of radiant energy such as a light bulb, or, light emitting diode can be energized with extra large voltage but for a time interval less than its response time. Alternately, where the sensor 14 is a thermal pile gas sensor, a source of radiant energy such as a photo emitter or heater element can be activated with a higher voltage pulse width a pulse with less than the response time of the respective device.

Those of skill in the art will understand, the above-noted variations and combinations produce detectors having lower average currents. This makes it possible to successfully energize an increased number of detectors, such as the system 10, from medium M.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A multi-sensor detector comprising:
a first ambient condition sensor;
a second, different ambient condition sensor;
control circuits, coupled to the sensors, responsive to a predetermined output from the first sensor for altering at least one of an amplitude drive parameter, a sample time parameter, a frequency drive parameter and a modulation parameter of the second sensor.

2. A detector as in claim 1 wherein the control circuits maintain a constant period for sampling the second sensor.

3. A detector as in claim 1 wherein the first sensor comprises a fire sensor and the second sensor comprises a gas sensor.

4. A detector as in claim 3 wherein when the fire sensor emits a signal indicative of a predetermined fire condition, the control circuit, responsive thereto, increases a sample interval of the second sensor.

5. A detector as in claim 4 wherein when the fire sensor ceases to emit the signal, the control circuit, responsive thereto, decreases the sample interval of the second sensor.

6. A detector as in claim 3 wherein the control circuit includes averaging circuitry coupled to the gas sensor.

7. A detector as in claim 6 wherein the averaging circuitry generates a running average of gas sensor output.

8. A detector as in claim 4 wherein the control circuitry includes executable instructions for generating a running average of gas sensor output.

9. A detector as in claim 8 wherein the executable instructions generate first and second running averages of gas sensor output wherein one of the averages is associated with one sample interval and the other with a different sample interval.

10. A detector as in claim 9 which includes a programmed processor.

11. A multi-sensor ambient condition detector comprising:
a fire sensor;
a gas sensor; and
control circuit wherein a duty cycle parameter of the gas sensor is switched from one value to another in response to a selected output from the fire sensor.

12. A detector as in claim 11 wherein the control circuit includes circuitry to operate the gas sensor at a first duty cycle in response to ta first output from the fire sensor and to switch to a second, greater, duty cycle in response to a second output from the fire sensor.

13. A detector as in claim 12 wherein the control circuit includes a processor and associated executable instructions for altering the duty cycle.

14. A detector as in claim 11 wherein the second sensor includes at least one of an emitter of energy and a sensing element wherein the emitter and the sensing element each exhibit respective response intervals and wherein a selected one of the emitter or the sensing element is activated with a selected electrical signal having an active time less than the respective response time.

15. A detector as in claim 14 wherein the selected electrical signal is a pulse with a width less than the respective response time.

16. A detector as in claim 14 wherein the second sensor comprises one of a non-dispersive infrared gas sensor, and a heated element gas sensor.

17. A detector as in claim 14 wherein the first sensor comprises a smoke sensor and the second sensor comprises a photo-acoustic gas sensor.

18. A detector as in claim 14 wherein the control circuit processes outputs from at least the gas sensor by forming first and second running averages wherein one average is associated with one duty cycle parameter and another is associated with a different duty cycle parameter.

19. A detector as in claim 18 wherein the control circuit reduces average required detector current by operating at the one value of duty cycle parameter in the absence of the selected output from the fire sensor.

20. A multi-sensor detector comprising:
a first, ambient condition sensor;
a second, different ambient condition sensor;
control circuits coupled to the sensors for responding to a condition indicating output from the first sensor by altering a sampling related parameter of the second sensor to increase the signal-to-noise ratio of output signal.

21. A detector as in claim 20 wherein the alterable sampling related parameter is selected from a class which includes altering a sample interval, altering an amplitude value, altering a frequency parameter, and altering a modulation parameter all while maintaining a constant sample period.

22. A detector as in claim 20 wherein the control circuits maintain a constant sample period for the second sensor.

23. A detector as in claim 20 wherein the first sensor comprises a fire sensor and the second sensor comprises a gas sensor.

24. A detector as in claim 23 wherein when the fire sensor emits a signal indicative of a predetermined fire condition, the control circuit, responsive thereto, increases the sample interval of the second sensor.

25. A detector as in claim 24 wherein when the fire sensor ceases to emit the signal, the control circuit, responsive thereto, decreases the sample interval of the second sensor.

26. A detector as in claim 23 wherein the control circuit includes averaging circuitry coupled to the gas sensor.

27. A detector as in claim 26 wherein the averaging circuitry generates a running average of gas sensor output.

28. A detector as in claim 24 wherein the control circuitry includes executable instructions for generating a running average of gas sensor output.

29. A detector as in claim 28 wherein the executable instructions generate first and second running averages of gas sensor output wherein one of the averages is associated with one sample interval and the other with a different sample interval.

30. A detector as in claim 29 which includes a programmed processor.

31. A multi-sensor detector comprising:
a first ambient condition sensor;
a second, different ambient condition sensor;
control circuits, coupled to the sensors, responsive to a predetermined output from the first sensor for switching the second sensor from a first level of resolution to a second greater level of resolution.

32. A detector as in claim 31 wherein the control circuits maintain a constant period for sampling the second sensor.

33. A detector as in claim 31 wherein the first sensor comprises a fire sensor and the second sensor comprises a gas sensor.

34. A detector as in claim 33 wherein when the fire sensor emits a signal indicative of a predetermined fire condition, the control circuit, responsive thereto, increases a sample interval of the second sensor to switch it to a second level of resolution.

35. A detector as in claim 34 wherein when the fire sensor ceases to emit the signal, the control circuit, responsive thereto, decreases the sample interval of the second sensor.

36. A multi-sensor detector comprising:
a first ambient condition sensor;
a second, different ambient condition sensor;
control circuits, coupled to the sensors, responsive to a predetermined output from the first sensor for switching the second sensor from a first mode of operation with a first signal-to-noise ratio to a second mode of operation with a second, improved signal-to-noise ratio.

37. A detector as in claim 36 wherein the first sensor comprises a fire sensor and the second sensor comprises a gas sensor.

38. A detector as in claim 36 wherein when the fire sensor emits a signal indicative of a predetermined fire condition, the control circuit, responsive thereto, alters a sample signal parameter of the second sensor to enter the second mode.

39. A detector as in claim 38 wherein when the fire sensor ceases to emit time signal, the control circuit, responsive thereto, returns the sample parameter of the second sensor to return it to the first mode.

40. A detector as in claim 38 wherein the control circuitry includes executable instructions for generating a running average of gas sensor output.

41. A detector as in claim 40 wherein the executable instructions generate first and second running averages of gas sensor output wherein one of the averages is associated with the first mode and the other with the second mode.

42. A multi-sensor detector comprising:
a first ambient condition sensor;
a second, different ambient condition sensor which includes a radiation-emitter and circuitry to sense radiation from the emitter;
control circuits coupled to the sensors, responsive to an output from the first sensor to alter a drive amplitude parameter of the emitter.

43. A detector as in claim 42 wherein the drive amplitude parameter has a first value when the first sensor is detecting the associated ambient condition and a lesser value when the first sensor is not detecting the associated ambient condition.

44. A detector as in claim 42 wherein the signal-to-noise ratio of the second sensor is greater when the first ambient condition sensor is detecting the associated ambient condition than when the first sensor is not detecting the associate ambient condition.

45. A detector as in claim 42 wherein average power dissipation thereof has a first value when the first ambient condition sensor is detecting the associated ambient condition and a lesser value when the first sensor is not detecting the associated ambient condition.

46. A detector as in claim 42 wherein the radiation emitter is one of a heated element, a light bulb and a solid state emitter of radiation.

47. A detector as in claim 42 wherein the drive parameter has a first amplitude value in response to an output from the first sensor and a second value in response to a selected, different output from the first sensor whereby the resolution the second sensor goes from a first to a second value in response thereto.

48. A multi-sensor detector comprising:
a first ambient condition sensor;
a second, different ambient condition sensor which includes a radiation emitter and circuitry to sense radiation from the emitter;
control circuits coupled to the sensors, responsive to an output from the first sensor to alter a drive time parameter of the emitter.

49. A detector as in claim 48 wherein the drive time parameter of the radiation emitter has a first value when the first sensor is detecting the associated ambient condition and a lesser value when the first said sensor is not detecting the associated ambient condition.

50. A detector as in claim 48 wherein the signal-to-noise ratio of the second sensor has a first value when the first ambient condition sensor is detecting the associated ambient condition and a lesser value when the first sensor is not detecting the associated ambient condition.

51. A detector as in claim 48 wherein the average power dissipation of the detector has a first value when the first ambient condition sensor is detecting the associated ambient condition and a lesser value when the first sensor is not detecting the associated ambient condition.

52. A detector as in claim 48 wherein the radiation emitter is one of a heated element, a light bulb and a solid state emitter of radiation.
